(19) United States
(12) Patent Application Publication
(10) Pub. No.: US 2015/0059359 A1
(43) Pub. Date: Mar. 5, 2015

(54) ROTARY BODY OF A PRINTING PRESS

(71) Applicant: Manroland Web Systems GmbH, Augsburg (DE)

(72) Inventors: Josef HAMMER, Plauen (DE); Thomas EISENSTEGER, Augsburg (DE)

(73) Assignee: Manroland Web Systems GmbH, Augsburg (DE)

(21) Appl. No.: 14/473,458

(22) Filed: Aug. 29, 2014

(30) Foreign Application Priority Data
Sep. 2, 2013 (DE) 10 2013 109 536.4

(51) Int. Cl. B41F 13/22; F25B 21/04

(52) U.S. Cl. CPC B41F 13/22; F25B 21/04; F25B 2321/025
USPC 62/3.2

(57) ABSTRACT

A rotary body of a printing press, in particular a printing press cylinder or a printing press roller, is disclosed. The rotary body includes a shaft, which is rotatably mountable on a printing press frame via bearings, and an outer surface which is temperature controllable. The outer surface is temperature controllable via at least one Peltier element integrated in the rotary body of a printing press, namely coolable and/or heatable.

This application claims the priority of German Patent Document No. DE 10 2013 109 536.4, filed Sep. 2, 2013, the disclosure of which is expressly incorporated by reference herein.

### BACKGROUND AND SUMMARY OF THE INVENTION

The invention relates to a rotary body of a printing press such as a printing press cylinder or a printing press roller. The invention furthermore relates to a method for operating such a rotary body of a printing press.

In a printing press, a multitude of rotary bodies are installed such as, for example, printing press rollers and printing press cylinders. The printing press cylinders can, for example, be transfer cylinders, forme cylinders, counter cylinders or the cylinders for various printing methods such as, for example, offset printing method and/or intaglio printing method and flexographic printing methods and the like. The rollers of a printing press can, for example, be paper guide rollers, ink transfer rollers of an inking couple and dampening solution transfer rollers of a dampening unit or a cooling roller for reducing the temperature of the substrate. These printing press cylinders as well as printing press rollers can be installed both in reel-fed printing presses and also in sheet-fed printing presses. The rotary bodies of a printing press can heat up during operation. In order to counteract such heating-up of rotary bodies of a printing press, it is known from practice to temperature control the rotary bodies of a printing press with the help of water cooling. Temperature controlling a rotary body of a printing press with the help of water cooling however is relatively complex since the cooling water on the one hand has to be conducted into the rotary body of a printing press and on the other hand conducted out of the same. To this end, rotary joints for water are required, in the region of which leakage can form. A further disadvantage of water cooling with justifiable expenditure is that the rotary bodies of a printing press can only be uniformly temperature controlled over the entire surface with the help of water cooling.

Starting out from this, the present invention is based on the object of creating a new type of rotary body for a printing press and a method for operating the same.

According to the invention, the outer surface is temperature controllable via at least one Peltier element integrated in the rotary body of a printing press, namely coolable and/or heatable. The temperature controlling of the outer surface of a rotary body of a printing press with the help of at least one Peltier element integrated in the rotary body of a printing press has the advantage that leakages of rotary joints for water can be avoided.

Preferentially, multiple Peltier elements are integrated in the rotary body, wherein preferentially surface portions of the outer surface are individually temperature controllable via each of the Peltier elements or Peltier elements which are connected into groups. By integrating multiple Peltier elements in the rotary body of a printing press, the surface of the same can be temperature controlled in portions. Different surface portions can be individually temperature controlled with little effort, as a result of which a defined temperature profile can be set along the surface of the rotary body of a printing press.

According to a further advantageous development, multiple Peltier elements next to one another and behind one another are integrated in the rotary body of a printing press in the axial direction and the circumferential direction, wherein preferentially a surface portion of the outer surface is individually temperature controllable via each of the Peltier elements. This arrangement of the Peltier elements in the axial direction next to one another and the circumferential direction one behind the other is preferred in order to set a defined temperature profile in the axial direction as well as in the circumferential direction along the surface of the rotary body of a printing press.

Preferentially, thermal insulating elements are arranged between Peltier elements that are adjacent or positioned next to one another and behind one another. Through the arrangement of the insulating elements between adjacent Peltier elements, interactions between the Peltier elements can be excluded in order to make possible an even more temperature controlling of the surface of the rotary body of a printing press in portions.

According to an alternative advantageous further development, at least one temperature sensor is integrated in the rotary body of a printing press, with which a temperature actual value can be collected in order to regulate the or each Peltier element dependent on a deviation of the temperature actual value from a temperature set point value. By way of the or each temperature sensor, a temperature closed-loop control can be established in the respective surface portions of the rotary body of a printing press.

According to an alternative advantageous further development, the rotary body of a printing press comprises an inner tube which, on an outer face in a radial cross-section, is formed circularly or at least triangularly or as a rounded polygon with at least three straight edges (rounded polygon) and on this outer face, carries the Peltier elements. The rotary body of a printing press furthermore comprises an outer tube which radially surrounds the inner tube at least in sections on an inner face which corresponds to the outer face of the inner tube and is formed circularly or at least triangularly or as a rounded polygon and which on an outer face provides the outer surface. Supply lines for the Peltier elements run within the inner tube. This configuration of the rotary body of a printing press is advantageous for a simple design realization.

Preferentially, the inner tube of the rotary body of a printing press is ventilated. Alternatively, the outer surface is additionally water temperature controlled, wherein the water temperature control serves for a basic temperature control and the temperature control via the or each Peltier element serves for precision temperature control.

Preferred further developments of the invention are obtained from the subclaims and from the following description. Exemplary embodiments of the invention are explained in more detail with the help of the drawings without being restricted to this.

### BRIEF DESCRIPTION OF THE DRAWINGS

FIG. 1 is a radial cross-section through an exemplary embodiment of a rotary body according to the invention;

FIG. 2 is a top view of the rotary body of a printing press according to the invention without an outer tube of the same; and

FIG. 3 is a detail of the rotary body of a printing press according to the invention in the region of a shaft of the same mounted on a printing press frame.

### DETAILED DESCRIPTION OF THE DRAWINGS

The invention relates to a rotary body of a printing press, such as for example a reel-fed printing press or a sheet-fed printing press. The rotary body of a printing press according to the invention can be a cylinder of a printing press or a roller of a printing press.

In particular when the rotary body of a printing press is designed as a cylinder of a printing press, the same can be a forme cylinder, a transfer cylinder or even an impression cylinder. In particular when the rotary body of a printing press is designed as a printing press roller, the same can be a paper guide roller, an ink transfer roller of an inking couple as well as a dampening solution transfer roller of a dampening unit or a cooling roller for reducing the temperature of the substrate.

These examples of printing press cylinders and printing press rollers are purely exemplary in nature. The invention is not restricted to these application cases but can also be employed on other rotary bodies.

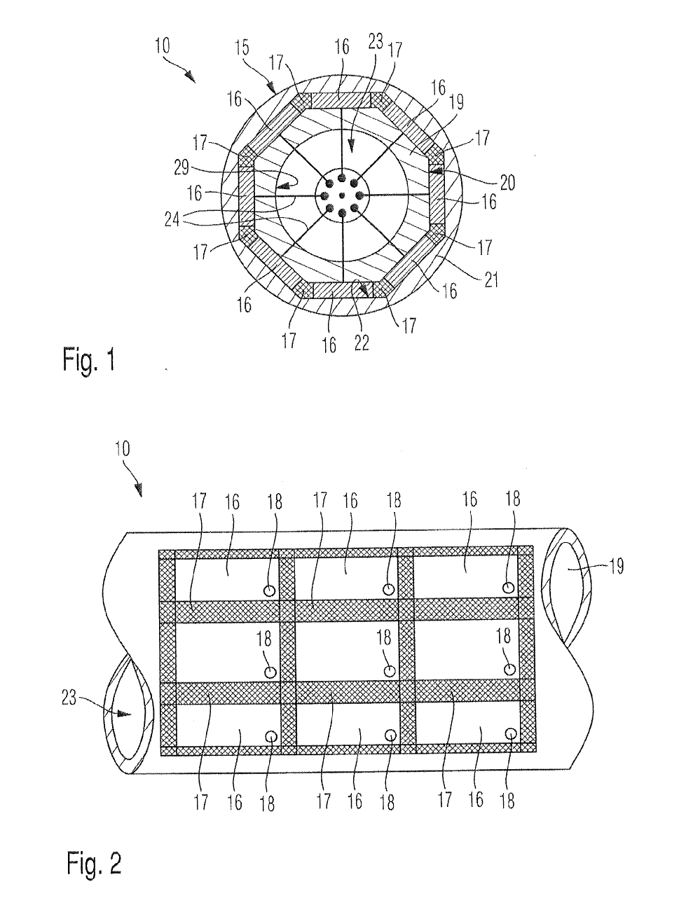

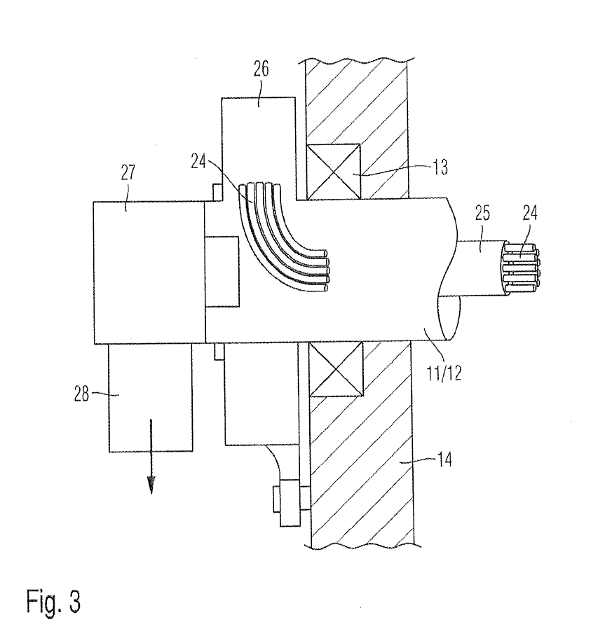

FIGS. 1 to 3 show different views of an exemplary embodiment of a rotary body of a printing press 10 according to the invention, wherein the rotary body of a printing press 10 comprises a shaft 11, which is rotatably mounted with lateral shaft portions 12 on a printing press frame 14 via bearings 13.

The rotary body of a printing press 10 has an outer surface 15, which seen in radial cross-section is contoured circularly. This outer surface 15 of the rotary body of a printing press 10 according to the invention is temperature controllable, namely coolable and/or heatable via at least one Peltier element 16 integrated in the rotary body of a printing press 10, wherein in the rotary body of a printing press 10 preferentially multiple such Peltier elements 16 are integrated, and wherein preferentially via each of the Peltier elements 16 or via Peltier elements 16 connected into groups a section of the outer surface 15 of the rotary body of a printing press 10 each can be individually temperature controlled.

In the axial direction and/or in the circumferential direction of the rotary body of a printing press 10, multiple Peltier elements 16 are integrated in the rotary body of a printing press 10 next to one another and/or behind one another. In the shown exemplary embodiment, eight Peltier elements each are positioned, seen in the circumferential direction of the rotary body of a printing press 10, behind one another and three Peltier elements 16 each are positioned, seen in the axial direction of the rotary body of a printing press 10, next to one another, so that accordingly altogether 24 Peltier element 16 are integrated in the rotary body of a printing press 10.

It is pointed out that the above number of the Peltier elements 16, which in the circumferential direction of the rotary body of a printing press 10 are positioned one behind the other and the above number of the Peltier elements 16 positioned in the axial direction of the same next to one another, are purely exemplary in nature.

The number of the Peltier elements 16 which are positioned in the axial direction next to one another is arbitrary and depends in particular on the axial construction length of the rotary body of a printing press 10 and on the number of the surface portions to be individually temperature controlled in the axial direction of the same.

The number of the Peltier elements 16 each positioned in the circumferential direction one behind the other preferentially amounts to at least two, preferentially three, in particular between eight and sixteen.

As is evident from FIGS. 1 and 2, a thermal insulating element 17 is arranged between each of the Peltier elements 16 positioned in the circumferential direction behind one another and between each of the Peltier elements 16 positioned in the axial direction next to one another, in order to avoid interaction between the individual Peltier elements 16 and in this way ensures an optimum individual temperature control of the individual surface portions of the rotary body of a printing press 10.

Temperature controlling of the rotary body of a printing press 10 with the help of the Peltier elements 16 can on the one hand take place in the sense of a control and on the other hand in the sense of a closed-loop control. In particular when temperature controlling of the outer surface 15 of the rotary body of a printing press 10 takes place in the sense of closed-loop control, preferentially multiple temperature sensors 18 are integrated in the rotary body of a printing press 10, wherein preferentially each surface portion to be individually temperature controlled is assigned an individual temperature sensor 18, with the help of which on the respective surface portion of the outer surface 15 of the rotary body of a printing press 10 an individual temperature actual value can be collected.

Alternatively, at least one contactlessly operating temperature sensor 18 for collecting the temperature actual value for the entire outer surface 15 or surface portions of the rotary body of a printing press 10 can be employed.

Dependent on a deviation of the respective temperature actual value from a corresponding temperature set point value, the Peltier element 16 assigned to the respective surface portion is individually closed-loop controlled, i.e., in order to set an individual temperature in the region of the respective surface portion of the outer surface 15 of the rotary body of a printing press 10.

In particular when no individual temperature controlling of the rotary body of a printing press 10 on surface portions of its outer surface 15 is required, all individual Peltier elements 16 shown in FIGS. 1 and 2 can be interconnected and jointly activated.

It is possible, furthermore, to interconnect and jointly activate or closed-loop control individual Peltier elements 16 even upon individual temperature controlling of the rotary body of a printing press on surface portions of its outer surface 15. In the variant shown in FIGS. 1 and 2, in which 24 Peltier elements 16 are integrated in the rotary body of a printing press 10, for example two Peltier elements 16 each adjacent in the circumferential direction can be interconnected and jointly activated in order to thus individually temperature control, for example, 12 surface portions of the outer surface 15 via the 24 Peltier elements 16. Peltier elements 16 which are adjacent in the circumferential direction and/or Peltier elements 16 which are adjacent in the axial direction can be interconnected and jointly activated.

In a particularly advantageous design embodiment of the rotary body of a printing press 10 according to the invention, the same comprises an inner tube 19, which on an outer surface 20 of the same seen in the radial cross-section of FIG. 1, is circular or at least triangular, and in the exemplary embodiment of FIG. 1 is octagonal, or is a rounded polygon in order to form, as seen in the circumferential direction, face portions on which at least one Peltier element 16 each can then be accommodated.

The rotary body of a printing press 10 furthermore comprises an outer tube 21, which radially surrounds the inner tube 19 on the outside at least in portions, namely at least in the region in which the Peltier elements 16 are positioned, wherein the outer tube 21 on an inner face 22 is contoured corresponding to the inner tube 19 on the outer face 20 of the latter, circularly or at least triangularly or as a rounded polygon with at least three flat faces, and in the exemplary embodiment of FIG. 1 octagonally, i.e., has the identical number of corners of the outer face 20 of the inner tube 19.

The outer face of the outer tube 21 forms the outer surface 15 of the rotary body of a printing press 10 to be temperature controlled.

Through this configuration of the rotary body of a printing press 10, the Peltier elements 16 on the one hand can be optimally arranged on the inner tube 19 of the rotary body of a printing press 10, and in addition to this an optimum contact of the same to the outer tube 21 of the rotary body of a printing press 10 can be ensured. The Peltier elements 16 are preferentially glued to the inner tube 19 and/or the outer tube 21 via a heat-conducting adhesive.

Preferentially, supply lines 24 for the Peltier elements 16 run within the inner tube 19 and thus in a channel 23 defined by the inner tube 19, wherein these supply lines 24 for the Peltier elements 16 are combined into a cable 25 and starting out from this cable 25 lead in the radial direction to the individual Peltier elements 16.

By way of a rotary joint 26, for example in the form of a slip ring assembly, the cable 25 carrying the supply lines 24 can be introduced starting out from the printing press frame 14 into the inner tube 19 of the rotary body of a printing press 10.

According to an advantageous further development of the invention it is provided to subject the inner tube 19 of the rotary body of a printing press 10 to ventilation with an airstream, in order to thus subject the interior space 23 of the inner tube 19 permanently to a through flow of air and in this way discharge heat from the rotary body of a printing press 10 via this air flow.

By way of a suitable rotary joint 27 for the air flow, an air stream can be introduced into the interior space 23 of the inner tube 19 and be discharged from the same, wherein the air flow through the interior space 23 of the inner tube 19 can be generated via a blower 28.

Alternatively or even additionally, the flow of an air stream through the inner tube 19 can also be realized through the mere rotation of the rotary body of a printing press. In this case, an inner face 29 of the inner tube 19 preferentially has a groove or a spiral with a defined pitch which, with rotating rotary body 10, then generates the air flow through the channel 23 defined by the inner tube 19.

According to a further advantageous further development of the invention it can be provided that the rotary body of a printing press 10 is temperature controlled not only via the Peltier elements 16 but additionally via water cooling. In this case, a basic temperature control of the outer surface 15 of the rotary body of a printing press 10 can then take place via the water cooling and precision temperature control of the outer surface 15 via the Peltier elements 16.

In an alternative configuration, the rotary body of a printing press 10 can be embodied without a separate inner tube 19. In this variant, a Peltier element 16 is attached to an inner face 22 of the outer tube with a circular or at least triangular or rounded polygonal cross-section with a preferentially heat-conducting adhesive or other connecting methods. It speaks for itself that mounting a rotary body 10 embodied in this way would have to take place on the outer face of the outer tube 21 or the inner face 22 of the outer tube 21 or on a separate if appropriate mechanically dismountable roller journal which is not shown in the figures.

The present invention furthermore relates to a method for operating such a rotary body 10, wherein the outer surface 15 of the same is temperature controlled via the Peltier elements 16 integrated in the rotary body of a printing press 10, namely cooled and/or heated.

As already explained, the Peltier element 16 in this case can be interconnected and uniformly activated in this case for the uniform temperature controlling of the rotary body of a printing press 10 on its outer surface 15. On the other hand, it is possible for establishing an individual temperature control of individual surface portions of the outer surface 15 of the rotary body of a printing press 10 to individually or by groups activate all individual Peltier elements 16 or also Peltier elements 16 connected into groups, preferentially closed-loop controlled individually or by groups.

It is thus possible, despite different loads on the outer surface 15 or effects on the outer surface 15 of the rotary body of a printing press 10, such as different pressures, inhomogeneous color profile or use of part-width webs, to realize a uniform temperature profile on the outer surface 15 of the rotary body of a printing press 10. Furthermore, the temperature profile with inhomogeneous loading, such as for example during the use of part-width webs or strands, can be adjusted to an inhomogeneous, and therefore, optimum temperature profile since it suits the requirement on the outer surface 15 of the rotary body of a printing press 10.

In addition to this, in the case of inhomogeneous loading or influencing of the rotary body of a printing press 10 through uneven temperature performance of the Peltier elements 16 activated or closed-loop controlled individually and/or by groups, an arbitrary, i.e., even or uneven, temperature profile on the outer surface 15 of the rotary body of a printing press in the circumferential or the axial direction can be realized so that this temperature profile can always be optimally adapted to the respective requirements.

### LIST OF REFERENCE NUMBERS

10 Rotary body
11 Shaft
12 Shaft section
13 Bearing
14 Printing press frame
15 Outer surface
16 Peltier element
17 Insulating element
18 Temperature sensor
19 Inner tube
20 Outer face
21 Outer tube
22 Inner face
23 Interior space/channel
24 Supply line
25 Cable
26 Rotary joint
27 Rotary joint
28 Blower
29 Inner face

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rotary body of a printing press, comprising:
a shaft, wherein the shaft is rotatably mountable on a printing press frame via bearings; and
an outer surface, wherein the outer surface is temperature controllable via at least one Peltier element which is integrated in the rotary body of a printing press.

2. The rotary body of a printing press according to claim 1, wherein the outer surface is coolable and/or heatable via the at least one Peltier element.

3. The rotary body of a printing press according to claim 1, wherein a plurality of Peltier elements are integrated in the rotary body of a printing press.

4. The rotary body of a printing press according to claim 1, wherein in an axial direction and/or in a circumferential direction of the rotary body of a printing press, a plurality of Peltier elements are integrated in the rotary body of a printing press next to one another and/or behind one another.

5. The rotary body of a printing press according to claim 3, wherein surface portions of the outer surface are individually temperature controllable via individual Peltier elements or Peltier elements which are connected into groups.

6. The rotary body of a printing press according to claim 1, wherein between adjacent Peltier elements at least one thermal insulating element is arranged.

7. The rotary body of a printing press according to claim 1, wherein in the rotary body of a printing press at least one temperature sensor is integrated or at least one contactless temperature sensor is used, with which a temperature actual value is collectable in order to regulate the at least one Peltier element dependent on a deviation of the temperature actual value from a temperature set point value.

8. The rotary body of a printing press according to claim 7, wherein each surface portion of the outer surface, which is assigned at least one Peltier element for temperature controlling of the respective surface portion, is assigned an individual temperature sensor for closed-loop control of the at least one Peltier element assigned to the surface portion.

9. The rotary body of a printing press according to claim to 3, further comprising:
an inner tube, wherein an outer face of the inner tube, in a radial cross-section, is formed circularly or triangularly or as a rounded polygon and wherein the plurality of Peltier elements are carried on the outer face of the inner tube;
an outer tube, wherein the outer tube at least in portions radially surrounds the inner tube on an inner face that corresponds to the outer face of the inner tube and wherein an outer face of the outer tube is the outer surface of the rotary body of a printing press; and
a plurality of supply lines for the plurality of Peltier elements, respectively, wherein the plurality of supply lines run within the inner tube.

10. The rotary body of a printing press according to claim 3, further comprising an outer tube with an inner face, wherein the inner face is formed in a radial cross-section circularly or triangularly or as a rounded polygon and wherein the plurality of Peltier elements are carried on the inner face.

11. The rotary body of a printing press according to claim 9, wherein the plurality of supply lines are disposed in an interior space or channel of the rotary body of a printing press.

12. The rotary body of a printing press according to claim 1, wherein the outer surface is water temperature controllable.

13. The rotary body of a printing press according to claim 1, wherein an interior space or channel of the rotary body of a printing press is ventilated.

14. The rotary body of a printing press according to claim 1, wherein the rotary body is a printing press cylinder or a printing press roller.

15. A method for operating a rotary body of a printing press, comprising the steps of:
controlling the temperature of an outer surface of the rotary body via a plurality of Peltier element integrated in the rotary body of the printing press.

16. The method according to claim 15, wherein the step of controlling the temperature of the outer surface includes cooling and/or heating the outer surface.

17. The method according to claim 15, wherein the step of controlling the temperature of the outer surface includes achieving an uneven or even temperature profile on the outer surface via activation or closed-loop control of the plurality of Peltier elements.

18. The method according to claim 15, wherein the step of controlling the temperature of the outer surface includes achieving an uneven or even temperature profile on the outer surface through individual or uneven temperature control performance of the plurality of Peltier elements in portions of the outer surface.
